(19) United States
(12) Patent Application Publication
(10) Pub. No.: US 2016/0155345 A1
(43) Pub. Date: Jun. 2, 2016

(54) ADAPTIVE LEARNING PLATFORM

(71) Applicants: Yanlin Wang, Cupertino, CA (US); Dylan Arena, Redwood City, CA (US)

(72) Inventors: Yanlin Wang, Cupertino, CA (US); Dylan Arena, Redwood City, CA (US)

(21) Appl. No.: 14/594,130

(22) Filed: Jan. 11, 2015

Related U.S. Application Data
(60) Provisional application No. 62/086,195, filed on Dec. 2, 2014.

(51) Int. Cl. G09B 7/00; G09B 5/02

(52) U.S. Cl. CPC G09B 7/00; G09B 5/02

(57) ABSTRACT

A cloud-based adaptive-learning platform (ALP) is provided to support an educational mobile or web application, with or without active Internet connections. The ALP is specifically designed to increase learners' engagement, optimize learning outcomes, and improve learning experience.

### RELATED APPLICATION

This patent claims priority to U.S. Provisional Application Ser. No. 62/086,195, entitled “ADAPTIVE LEARNING PLATFORM,” which was filed on Dec. 2, 2014, and is hereby incorporated herein by reference in its entirety.

### FIELD OF THE DISCLOSURE

This disclosure relates generally to educational technology or e-learning and, more particularly, to methods and systems of a cloud-based adaptive learning platform (ALP).

### BACKGROUND

Kids today engage with tons of interactive, learning-relevant contents in a wide variety of contexts. However, so far, each of these contexts only gets a sliver of data—a glimpse of the learner, a part of the elephant—if any at all. And with only a sliver of data, conclusions must be drawn through extrapolation. This may impact the learning experience and outcomes, e.g., impeding the learning progress.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a block diagram of an example cloud-based ALP system architecture.

FIG. 2 is a block diagram of an example ALP client architecture.

FIG. 3 is a flowchart showing a use case of data flow between an ALP client and an ALP cloud server.

### DETAILED DESCRIPTION

It should be understood at the outset that although illustrative implementations of one or more embodiments of the present disclosure are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

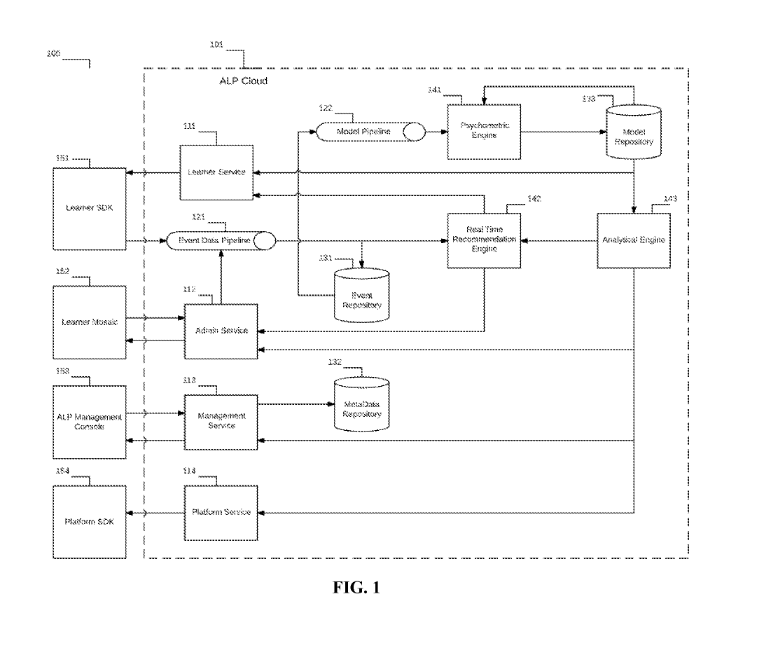

In FIG. 1, a block diagram of an example ALP system 100 implemented as described herein provides a learner with a cloud-based platform (ALP) that can support an educational mobile or web application, with or without active Internet connections.

According to an illustrated example, an ALP treats data from each learning-relevant context (e.g. an educational app, an educational test/assessment, parents' responses to questions, teachers' observations, etc.) as a source of evidence that contributes its observations to a central repository. This central repository uses the evidence to create a universal psychometric model for each learner. The model then feeds information back to the sources of evidence to help each of them personalize the learner's experience and understand the efficacy of their own content. The model also reveals interesting patterns that help ALP, teachers, parents, and creators of learning-relevant contexts to better support the learner. Altogether, ALP is specifically designed to increase learners' engagement, optimize learning, and improve outcomes.

As shown in FIG. 1, an ALP cloud 101 provides services such as Learner Service 111, Admin Service 112, Management Service 113, and Platform Service 114. The ALP cloud 101 contains repository components such as an Event Repository 131, a Model Repository 133 and a Metadata Repository 132. The ALP cloud 101 contains pipeline components such as a Model Pipeline 122 and an Event Data Pipeline 121.

According to some aspects of some embodiments, a distributed, multi-source, multi-dimensional evaluation evidence storage is provided to optimize both real-time and batch evidence event processing.

In an embodiment, the Learner Service 111 is a web-service layer that is responsible for exchanging learner models and associated metadata between a Learner Software Development Kit (SDK) 151 and the ALP cloud 101. The Learner SDK 151 is a complex psychometric event-processing system running on a mobile device as a full-featured, client-side ALP presence.

In an embodiment, the Admin Service 112 is a web-service layer that provides learner-management capability (e.g., ability to create/edit/delete learners and their info) for a Learner Mosaic 152 or other parent- or teacher-facing products. The Learner Mosaic 152 provides parents with (a) insights about their children's progress, (b) specific activity recommendations to enrich their children's learning, and (c) questions to enrich their children's learner profiles by providing evidence for growth in specific skills.

According to some aspects of some embodiments, the Learner Mosaic provides parents or teachers a learner's development progress of skills across various areas such as thinking skills, physical skills, social emotional skills, character skills, knowledge, etc.

In an embodiment, the Management Service 113 is a web-service layer that provides aggregated data for sets of learners, to allow ALP partners to investigate how learners are progressing within their products. This service also provides functionality for ALP partners to create/edit/delete metadata in the Metadata Repository 132. As shown in FIG. 1, a Management Console 153 uses the Management Service 113 to provide ALP partners with (a) authoring tools to create/edit/delete metadata in the Metadata Repository 133 about learning evidence within their products (e.g., prompts for learners or questions for parents) and (b) a dashboard to investigate aggregated data about engagement and learning outcomes. The Metadata Repository 132 is a central data store for versioned learner models.

In an embodiment, the Platform Service 114 is a web-service layer that provides specific service used by a Platform SDK 154 for ALP partners. An ALP partner manages ecosystems containing plurality of products from different vendors.

As shown in FIG. 1, the services provided by the ALP cloud 101 is enabled by data processing engines including but limited to Psychometric Engine 141, Real Time Recommendation Engine 142 and Analytic Engine 143.

In an embodiment, the Psychometric Engine 141 is a scalable item-response theory (IRT) computation engine that evaluates event data to produce a psychometric model of a learner. A learner's psychometric model contains information such as Learner Ability. A Learner Ability is a score representing a learner's ability relative to other learners with regard to certain learning-relevant context. The Psychometric Engine 141 receives learner behavior event data stored at the Event Repository 131 via the Model Pipeline 122. The Event Repository 131 is a distributed columnar data store that is optimized for psychometric event data. In an embodiment, the Model Pipeline 122 is a data processing pipeline with scalable workflow control and state management that feeds event data to the Psychometric Engine 141.

According to some aspects of some embodiments, a distributed, multi-source, multi-dimensional, item-response theory (IRT) computation system is provided that uses a combination of server-side distributed computing and client-side computing to function at the massive scale.

In an embodiment, the Analytical Engine 143 is a data service that provides interactive data-query and data-aggregation capacities. The Analytical Engine 143 takes inputs of learner models from the Model Repository 133, and outputs results to The Real Time Recommendation Engine 142, and ALP services including the Admin Service 112, the Management Service 113, and the Platform Service 114. The Model Repository 133 is a distributed columnar data store for versioned learner models.

According to some aspects of some embodiments, a suite of analytical tools are provided to educational application developers for evaluating their own application's impacts on learning outcomes, learner engagement, learner retention, and other relevant metrics.

In an embodiment, the Real Time Recommendation Engine 142 is a rule-based correlation engine that provides the best next question for the learner, as well as insights and suggestions for parents/teachers, based on the learner model. The Real Time Recommendation Engine 142 takes inputs from the Analytical Engine 143 and the event data via an Event Data Pipeline 121, and outputs results to ALP services including the Admin Service 112 and Learner Service 111. In an embodiment, the Real Time Recommendation Engine 142 outputs insights and recommendations in real-time when correlation rule is triggered. In an alternative embodiment, the Real Time Recommendation Engine 142 outputs insights and recommendations triggered by events that have happened during a short period in the past, e.g., in the past hour. In an alternative embodiment, the Real Time Recommendation Engine 142 outputs recommendations triggered by events that have happened during a long period in the past, e.g., in the past week. In an embodiment, the Event Data Pipeline 121 is a scalable distributed data pipeline that is responsible for event ingestion and processing. An event for ALP is an evidence of learning, such as a learner's response to a prompts or a parent's input about learner activity, along with contextual metadata about that evidence. In an embodiment, the Event Data Pipeline 121 is built with a staged event-driven architecture.

According to some aspects of some embodiments, the Real Time Recommendation Engine 142 makes recommendations, e.g., the best subsequent prompt to present to the learner, and/or the best subsequent application to expose to the learner, and/or the best tip to present to the learner, parents, teachers, or other stakeholders.

According to some aspects of some embodiments, the Real Time Recommendation Engine 142 makes recommendations based upon not only the estimation of the learner's proficiency in the relevant learning domains but also other relevant contextual data such as eventual learning outcomes of previous learners, learner preferences for particular themes or interaction types, etc.

According to some aspects of some embodiments, the Real Time Recommendation Engine 142 is an extendable recommendation system that can pull information from external systems (e.g., learning- or content-management systems) in combination of the embedded extendable knowledge-base to provide personalized feedback such as recommended activities, interventions, or other next steps. The feedback is available through web-services APIs, so that the recommendations can be surfaced in a variety of products.

In an embodiment, the ALP cloud 101 is an open platform with pluggable modular engines such as the Psychometric Engine 141, the Real Time Recommendation Engine 142 and the Analytic Engine 143. In an embodiment, the ALP cloud 101 is extendable wherein developers can contribute to the ALP cloud 101 components including but not limited to recommendation rules and contents, assessment models, and evaluation models.

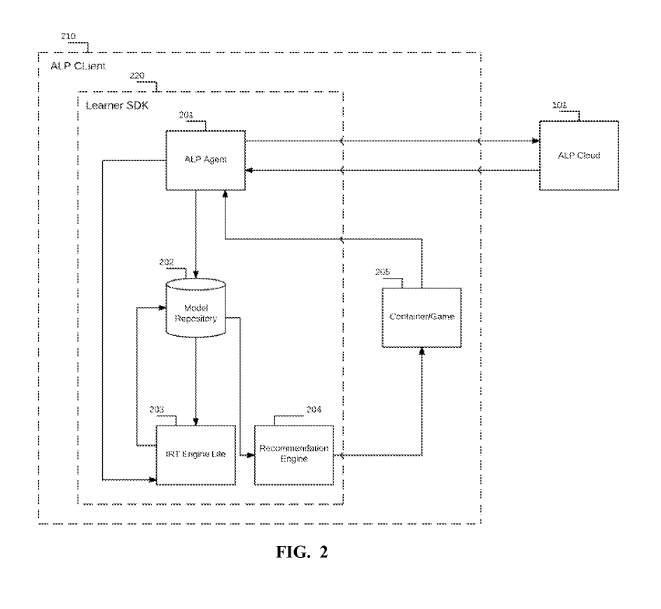

In FIG. 2, a block diagram of an example ALP client architecture 210 implemented as described herein consists of Learner SDK 220 and Container/Game 205. In an embodiment, the Learner SDK 220 is responsible for communicating with the ALP Cloud 101 and managing local adaptivity in online or offline mode. In another embodiment, the Learner SDK 220 is responsible for persisting and updating learner models, processing events, and recommending prompts based on the current learner model to the Container/Game 205.

According to some aspects of some embodiments, the Learner SDK 220 can be embedded into an educational mobile or web application to provide client-side evaluation of learner responses to prompts within the application, learner proficiency estimation, recommendation of subsequent prompts within the application, and communication with ALP.

As shown in FIG. 2, the Learner SDK 220 consists of four components. An ALP Agent (AA) 201, a Model Repository (MR) 202, an IRT Engine Lite (IEL) 203, and a Recommendation Engine (RE) 204.

In an embodiment, the AA 201 handles queuing, caching, and sending events (e.g., learner responses to prompts) to the ALP Cloud 101. The AA 201 receives dated learner models and other metadata (prompts, item difficulties, notifications to be dispatched, etc.) from the ALP Cloud 101. The AA 201 creates attempts from events for subsequent processing by the IEL 203. The AA 201 manages worker queues and threads for processing events and attempts, and manages local storage quota, event batching, and messaging recovery.

According to some aspects of some embodiments, the AA 201 is provided with an optional adaptor to be automatically integrated into an educational application without requiring the education application to alter its existing code.

In an embodiment, an efficient communication protocol is employed for transmitting arbitrary psychometric events between the AA 201 and the ALP Cloud 101. In an embodiment, this protocol combines “push” and “pull” messages into a single channel. The ALP Cloud 101 encapsulates operation commands in messages in response to the requests by the AA 201. Correspondingly, the AA 201 de-capsulates and executes the embedded operation commands, e.g., to pull additional metadata from the ALP cloud 101.

In an embodiment, the MR 202 is responsible for storing versioned models of learners, item difficulties, prompt sets, item/prompt mappings, etc. The MR 202 manages storage quotas, model versioning, model synchronization between client and server (server-authoritatively), and provides notifications of model changes.

In an embodiment, the IEL 203 is responsible for processing attempts (asynchronously and in a background thread) using a Bayesian IRT approach. The IEL 203 updates models of learners and item difficulties, processes learner-model and item-difficulty notifications and updates cached models.

In an embodiment, the RE 204 is responsible for processing model changes of learner ability and/or item difficulty. The RE 204 recommends to the ALP partner's product (the “Container/Game” 205) the best next prompt to show to the learner.

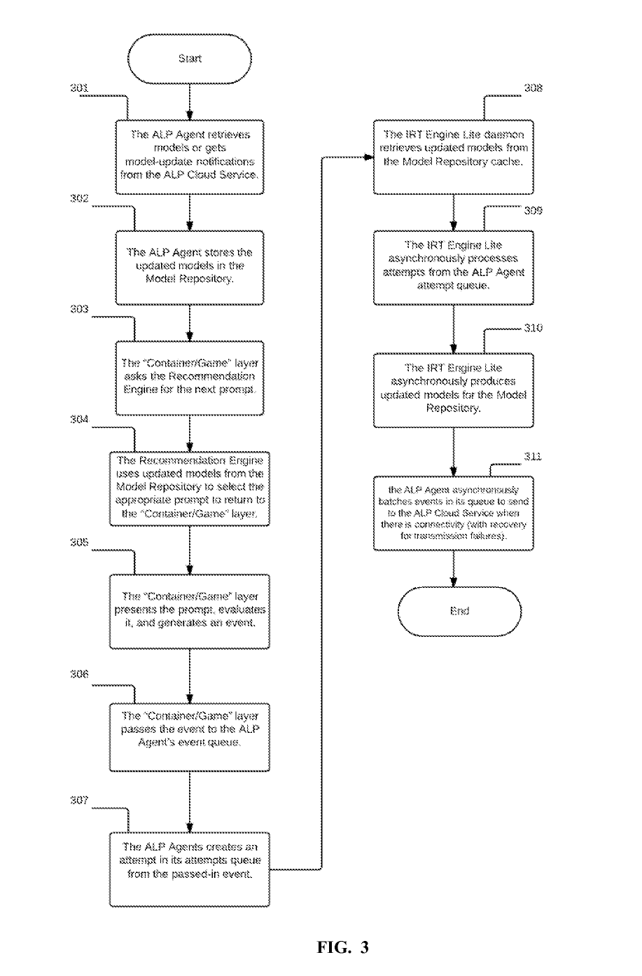

As shown in FIG. 3, in an embodiment, during operation, the ALP Agent 201 retrieves models or gets model-update notifications from the ALP Cloud 101 (block 301). The ALP Agent 201 then stores the updated models in the Model Repository 202 (block 302). The “Container/Game” 205 layer asks the Recommendation Engine 204 for the next prompt (block 303). The Recommendation Engine 204 then uses updated models from the Model Repository 202 to select the appropriate prompt to return to the “Container/Game” 205 layer (block 304). The “Container/Game” 205 layer presents the prompt, evaluates it, and generates an event (block 305). The “Container/Game” layer passes the event to the ALP Agent 201′s event queue (block 306). The ALP Agent 201 creates an attempt in its attempts queue from the passed-in event (block 307). The IRT Engine Lite 203 daemon retrieves updated models from the Model Repository 202 cache (block 308). The IRT Engine Lite 203 asynchronously processes attempts from the ALP Agent 201 attempt queue (block 309). The IRT Engine Lite asynchronously produces updated models for the Model Repository 202 (block 310). Meanwhile, the ALP Agent 201 asynchronously batches events in its queue to send to the ALP Cloud 101 when there is connectivity (e.g., with recovery for transmission failures).

What is claimed is:

1. A system of a cloud-based adaptive learning platform, the system comprising:
a plurality of data processing engines configured to:
receive data from a plurality of learning-relevant contexts as sources of learning evidence; and
build a psychometric model for a learner; and
provide personalized learning recommendations; and
provide analytical information to the sources of learning evidence.

2. The system of claim 1, wherein said plurality of data processing engines further comprising a psychometric engine that evaluates learning event data to produce a psychometric model of a learner.

3. The system of claim 1, wherein said plurality of data processing engines further comprising an analytical engine that provides interactive data-query and data-aggregation capacities.

4. The system of claim 1, wherein said plurality of data processing engines further comprising a recommendation engine that provides the best next question for a learner and learning suggestions for parents and/or teachers based on the psychometric model of the learner.

5. The system of claim 1, wherein said plurality of data processing engines are pluggable software modules that can be extended or replaced.

6. The system of claim 1, wherein said plurality of learning-relevant contexts are one or more than one of:
an educational app;
an educational test;
an educational assessment;
parents' responses to questions; and
teachers' observations.

7. The system of claim 1, wherein said psychometric model comprises learner ability information that represents a learner's ability relative to other learners with regard to the one or more than one said learning-relevant contexts.

8. A method for data processing in a cloud-based adaptive learning platform, the method comprising:
receiving data from a plurality of learning-relevant contexts as sources of learning evidence; and
building a psychometric model for a learner; and
providing personalized learning recommendations; and
providing analytical information to the sources of learning evidence.

9. The method of claim 8, wherein said plurality of learning-relevant contexts are one or more than one of:
an educational app;
an educational test;
an educational assessment;
parents' responses to questions; and
teachers' observations.

10. The method of claim 8, wherein said psychometric model comprises learner ability information that represents a learner's ability relative to other learners with regard to the one or more than one said learning-relevant contexts.

11. A method for operating a client with an adaptive learning platform cloud, the method comprising:
evaluating a learner's responses to a plurality of prompts within the client;
estimating the learner's proficiency;
recommending a plurality of subsequent prompts within the client;
performing data synchronization with the adaptive learning platform cloud.

12. The method of claim 11, wherein the client operates locally when there is no network connectivity with the adaptive learning platform cloud.

13. The method of claim 11, wherein the data synchronization is performed when there is network connectivity with the adaptive learning platform cloud.
